(19) United States
(12) Patent Application Publication
(10) Pub. No.: US 2025/0112508 A1
(43) Pub. Date: Apr. 3, 2025

(54) LAMINATED CORE, MOTOR, AND METHOD FOR MANUFACTURING LAMINATED CORE

(71) Applicant: NIDEC CORPORATION, Kyoto (JP)

(72) Inventors: Yuya DANJO, Kyoto (JP); Yoshihiro MATSUMOTO, Kyoto (JP)

(21) Appl. No.: 18/898,678

(22) Filed: Sep. 27, 2024

(30) Foreign Application Priority Data
Sep. 29, 2023 (JP) 2023-170702

(51) Int. Cl. H02K 1/16; H02K 15/02

(52) U.S. Cl. CPC H02K 1/16; H02K 15/021

(57) ABSTRACT

A laminated core includes a first connecting portion and a first groove. The first connecting portion connects back yoke portions in the stacking direction on an outer peripheral surface of a portion of a back yoke staked portion, the portion including an end portion on one side in the extending direction of an iron core piece. The first groove is located in a direction opposite to a first direction that is a direction from one side edge toward the other side edge in the iron core piece across the one side edge in the extending direction of the iron core piece with respect to the first connecting portion, and extends in the stacking direction of the back yoke stacked portion on the outer peripheral surface of the back yoke stacked portion.

### CROSS-REFERENCE TO RELATED APPLICATIONS

The present invention claims priority under 35 U.S.C. § 119 to Japanese Patent Application No. 2023-170702 filed on Sep. 29, 2023, the entire content of which is incorporated herein by reference.

### FIELD OF THE INVENTION

The present invention relates to a laminated core, motor, and a method for manufacturing a laminated core.

### BACKGROUND

A manufacturing method for manufacturing a laminated core by winding a band-shaped iron core piece forming member while deforming the member in a spiral shape is known. For example, conventionally, there is known a manufacturing method for manufacturing a spiral type rotary machine core by laminating a comb-shaped sheet having a band-shaped core back portion and a large number of parallel tooth portions by spirally winding the comb-shaped sheet, with the band-shaped core back portion being positioned radially outward of the spiral and the parallel tooth portions being positioned radially inward of the spiral. In the conventional manufacturing method, when the axial length of a lamination obtained by laminating the comb-shaped sheets reaches a predetermined value, the lamination is cut out from the comb-shaped sheet. In this way, after the lamination is cut out from the comb-shaped sheet, a finishing step such as welding, heat treatment, correction, surface removal, cutting, deburring, or cleaning is performed on the lamination as necessary. Through the above steps, the spiral rotary machine core is completed.

Incidentally, a laminated core manufactured by winding a band-shaped iron core piece forming member while deforming the member in a spiral shape has a lamination constituted by an iron core piece wound and laminated in a spiral shape. In such a lamination of a laminated core, it is necessary to fix the end of the core piece in order to prevent the end of the core piece spirally wound and laminated from being turned up.

On the other hand, in the manufacturing process of the laminated core, the iron core piece constituting the lamination is cut out from the iron core piece forming member according to the height of the laminated core in the axial direction. It is desired to suppress generation of an end material when the iron core piece is cut out from the iron core piece forming member.

### SUMMARY

A laminated core, according to an exemplary embodiment of the present invention, includes a lamination having a cylindrical shape and extending along an axis, the lamination being formed of an iron core piece, the iron core piece including a back yoke portion having a plate shape and extending in a shape of a spiral about the axis; a plurality of tooth portions protruding inward in a radial direction of the spiral from the back yoke portion; and a plurality of slits extending radially outward of the spiral from an inner peripheral end surface of the back yoke portion between a pair of the tooth portions adjacent to each other in the extending direction among the plurality of tooth portions, the back yoke portions, the tooth portions, and the slits being stacked in a state of overlapping each other in a thickness direction respectively. The lamination includes a cylindrical back yoke stacked portion in which the back yoke portions are stacked in the thickness direction, a plurality of tooth stacked portions in which the plurality of tooth portions are stacked in the thickness direction, arranged in a circumferential direction, and protruding radially inward from the inner peripheral surface of the back yoke stacked portion, and a plurality of slit stacked portions in which the plurality of slits are stacked in the thickness direction, arranged in the circumferential direction, and extending radially outward from an inner peripheral end surface of the back yoke stacked portion between a pair of the tooth stacked portions adjacent to each other. The laminated core includes a first connecting portion that connects the back yoke portions in the stacking direction on an outer peripheral surface of a portion of the back yoke staked portion, the portion including an end portion on one side in the extending direction of the iron core piece, and a first groove that is located in a direction opposite to a first direction that is a direction from one side edge toward the other side edge in the iron core piece across the one side edge in the extending direction of the iron core piece with respect to the first connecting portion, and extends in the stacking direction of the back yoke stacked portion on the outer peripheral surface of the back yoke stacked portion.

A laminated core manufacturing method according an exemplary embodiment of the present invention is a method for manufacturing a laminated core having a cylindrical shape and extending along the axis, by spirally winding an iron core piece forming member extending in a band shape in one direction while deforming the iron core piece forming member toward one side in the width direction. The laminated core manufacturing method includes a punching step of punching a plate-shaped steel sheet to form the iron core piece forming member, the iron cor piece forming member including: a back yoke portion having a plate shape and extending in the one direction; a plurality of tooth portions protruding from the back yoke portion to one side in the width direction; and a plurality of slits extending from an end face on one side in the width direction to another side in the width direction in the back yoke portion between a pair of the tooth portions adjacent to each other in the one direction among the plurality of tooth portions; and a pair of recesses located at end portions on the other side in the width direction in the back yoke portion, a stacking step of deforming the iron core piece forming member to one side in the width direction and winding the iron core piece forming member in a spiral shape, and stacking the back yoke portions, the tooth portions, the slits, and the recesses in the axial direction in an overlapping manner, respectively; a cutting step of forming an iron core piece by cutting between one recess and another recess of the pair of recesses in a state where the iron core piece forming member is stacked in the axial direction; and a connecting step of joining the back yoke portions in a stacking direction on an outer peripheral surface of a back yoke stacked portion in which the back yoke portions are stacked in the axial direction in a recess close to a cut end portion of the iron core piece.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view illustrating a schematic configuration of a laminated core according to a first embodiment;

FIG. 2 is a plan view illustrating a schematic configuration of the laminated core illustrated in FIG. 1;

FIG. 3 is a partially enlarged view of a part III illustrated in FIG. 2;

FIG. 4 is an exploded side view illustrating the laminated core in an exploded manner;

FIG. 5 is a flowchart illustrating a method for manufacturing the laminated core according to the first embodiment;

FIG. 6 illustrates punching of a steel sheet;

FIG. 7 is a diagram for explaining a stacking step and a cutting step;

FIG. 8 is a perspective view illustrating a schematic configuration of a laminated core according to a second embodiment;

FIG. 9 is a perspective view illustrating a schematic configuration of a laminated core according to a third embodiment;

FIG. 10 is a plan view illustrating a schematic configuration of the laminated core illustrated in FIG. 9;

FIG. 11 is a plan view illustrating an iron core piece forming member for manufacturing a conventional laminated core;

FIG. 12 is a laminated pattern table of a conventional laminated core;

FIG. 13 is a plan view illustrating an iron core piece forming member for manufacturing a laminated core;

FIG. 14 is a laminated pattern table of the laminated core according to the third embodiment;

FIG. 15 is a plan view illustrating an iron core piece forming member for manufacturing the laminated core according to the third embodiment; and

FIG. 16 is a cross-sectional view illustrating a schematic configuration of a motor according to an embodiment.

### DETAILED DESCRIPTION

Hereinafter, exemplary embodiments of the present invention will be described in detail with reference to the drawings. The same or corresponding parts in the drawings are denoted by the same reference numerals, and the description thereof will not be repeated. In addition, the dimensions of the components in the drawings do not faithfully represent the actual dimensions of the components, the dimensional ratios of the components, and the like.

In the following description, a direction in which an axis Q of a spiral of an iron core piece extending in a spiral shape and an axis Q of a cylinder of a cylindrical lamination extend is referred to as an axial direction, and a direction orthogonal to the axis Q is referred to as a radial direction. In the following description, the shape of the spiral of the iron core piece is also referred to as a “spiral shape”.

In the following description, a direction of a plate thickness of a member in a plate shape is referred to as a thickness direction of the member. The sentence, “when the member is viewed in the thickness direction”, means that the thickness direction coincides with a direction of a line of sight. For example, “when the iron core piece forming member is viewed in the thickness direction” means viewing a surface of the iron core piece forming member from a position away from the iron core piece forming member in the thickness direction.

In the following description, “identical” includes not only a case of being strictly identical but also a range that can be regarded as being substantially identical.

In the following description, expressions such as “fixed”, “connected”, “linked”, “joined” and “attached” (hereinafter referred to as “fixed” or the like) include not only the case where members are directly fixed to each other or the like, but also the case where members are fixed to each other or the like via another member. That is, in the following description, the expression such as fixing includes the meaning of direct and indirect fixing between members.

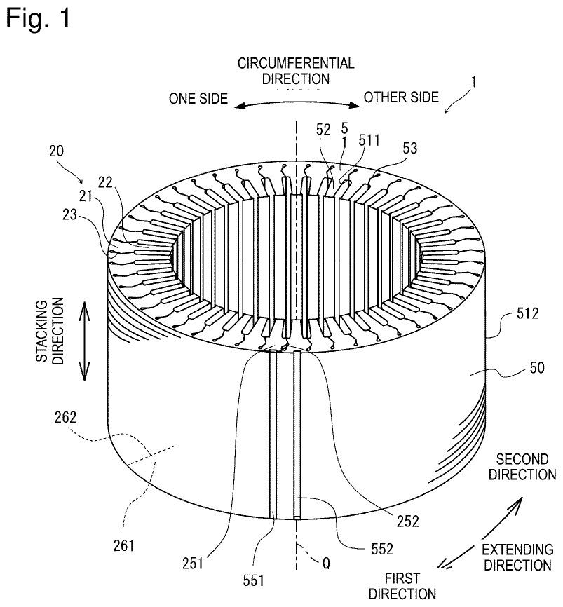

With reference to FIGS. 1 to 4, a laminated core 1 according to a first exemplary embodiment of the present invention will be described. FIG. 1 is a perspective view illustrating a schematic configuration of the laminated core 1.

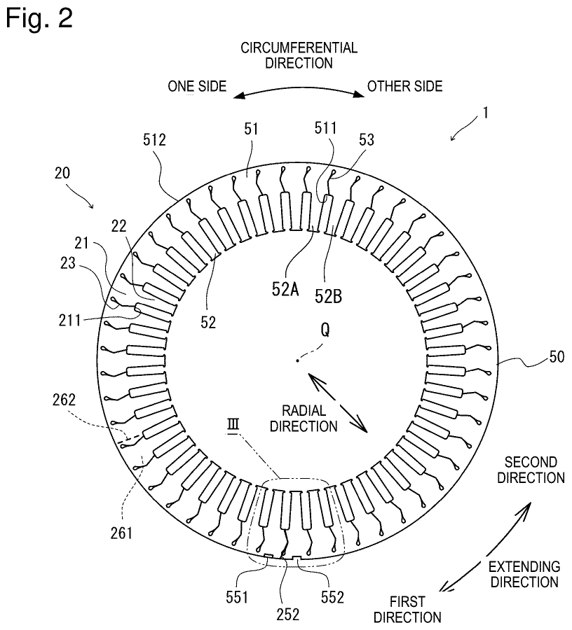

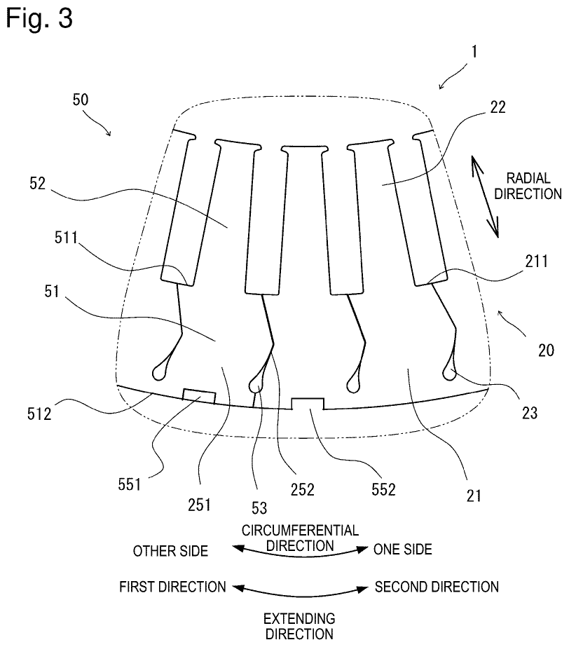

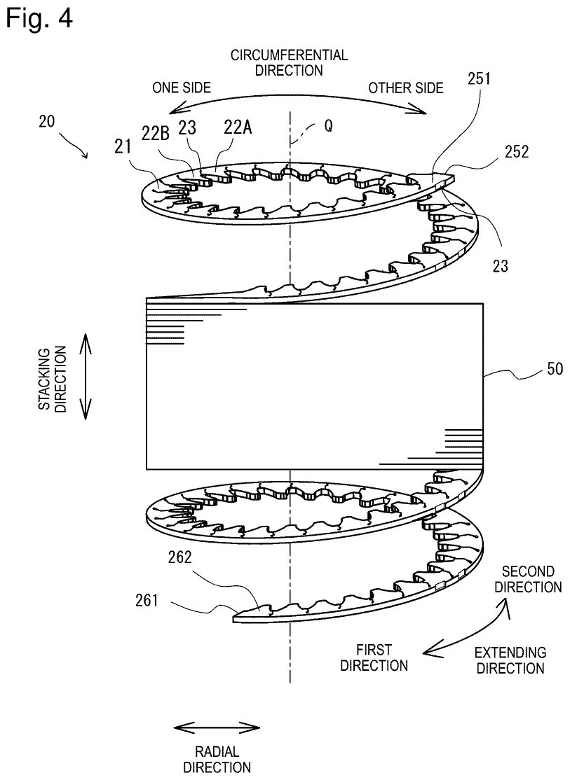

FIG. 2 is a plan view illustrating a schematic configuration of the laminated core 1. FIG. 3 is a partially enlarged view of a part III illustrated in FIG. 2. FIG. 4 is an exploded side view illustrating the laminated core 1 in an exploded manner.

The laminated core 1 has a cylindrical lamination 50 extending along the axis Q. The lamination 50 includes an iron core piece 20 spirally wound and stacked in the stacking direction.

The iron core piece 20 includes a back yoke portion 21, a plurality of tooth portions 22, and a plurality of slits 23.

The back yoke portion 21 is a plate-like portion extending in a spiral shape around the axis Q. The plurality of tooth portions 22 protrude radially inward of the spiral from the back yoke portion 21.

As illustrated in FIGS. 2 and 3, the plurality of slits 23 extend radially outward of the spiral from an inner peripheral end surface 211 of the back yoke portion 21 between a pair of tooth portions 22A and 22B adjacent to each other in the extending direction among the plurality of tooth portions 22.

In the iron core piece 20, the back yoke portions 21, the tooth portions 22, and the slits 23 are each staked in a state of overlapping each other in the thickness direction.

The lamination 50 includes a back yoke stacked portion 51, a plurality of tooth staked portions 52, and a plurality of slit stacked portions 53.

The back yoke stacked portion 51 has a cylindrical shape in which the back yoke portions 21 are staked in the thickness direction. In each of the plurality of tooth staked portions 52, the plurality of tooth portions 22 are staked in the thickness direction, and the plurality of tooth staked portions are arranged in the circumferential direction, and protrude radially inward from an inner peripheral surface 511 of the back yoke stacked portion 51.

In each of the plurality of slit stacked portions 53, the plurality of slits 23 are staked in the thickness direction, and the plurality of slit stacked portions 53 are arranged in the circumferential direction, and extend radially outward from the inner peripheral surface 511 of the back yoke stacked portion 51 between a pair of tooth staked portions 52A and 52B adjacent to each other.

The laminated core 1 includes a first connecting portion 551 and a first groove 552.

The first connecting portion 551 connects the back yoke portions 21 in the staking direction on the outer peripheral surface 512 of the portion of the back yoke stacked portion 51 including the one-side end portion 251 in the extending direction of the iron core piece 20. The first connecting portion 551 is formed by welding, in the staking direction, the back yoke portions 21 staked in the staking direction, for example.

When the laminated core 1 is viewed in the axial direction, the first groove 552 is located in a direction opposite to a first direction that is a direction from one side edge 252 toward the other side edge 262 in the iron core piece 20 across the one side 3252 in the extending direction of the iron core piece 20 respect to the first connecting portion 551, and extends in the stacking direction of the back yoke stacked portion 51 on the outer peripheral surface 512 of the back yoke stacked portion 51.

As illustrated in FIG. 3, when the laminated core 1 is viewed in the axial direction, the first groove 552 is positioned on the outer peripheral surface 512 of the back yoke stacked portion 51 so as to be aligned with the first connecting portion 551 in the circumferential direction with the slit stacked portion 53 being interposed therebetween.

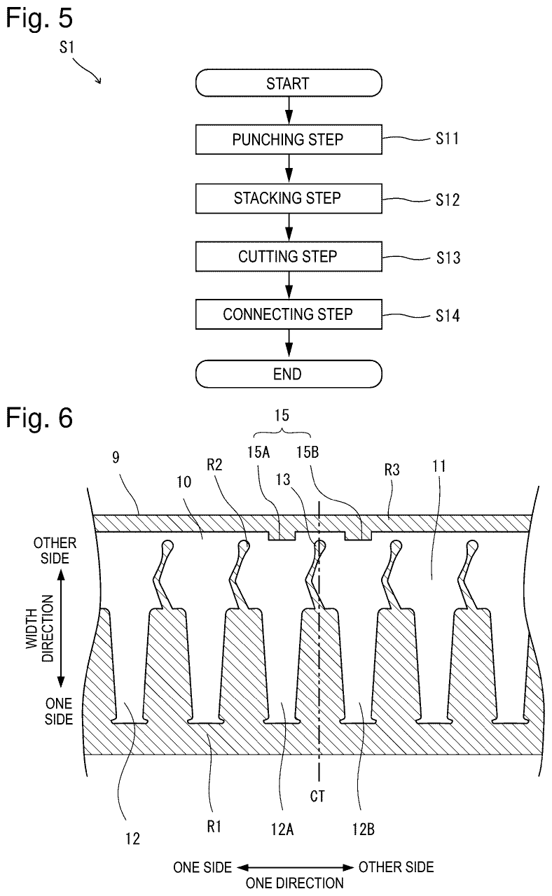

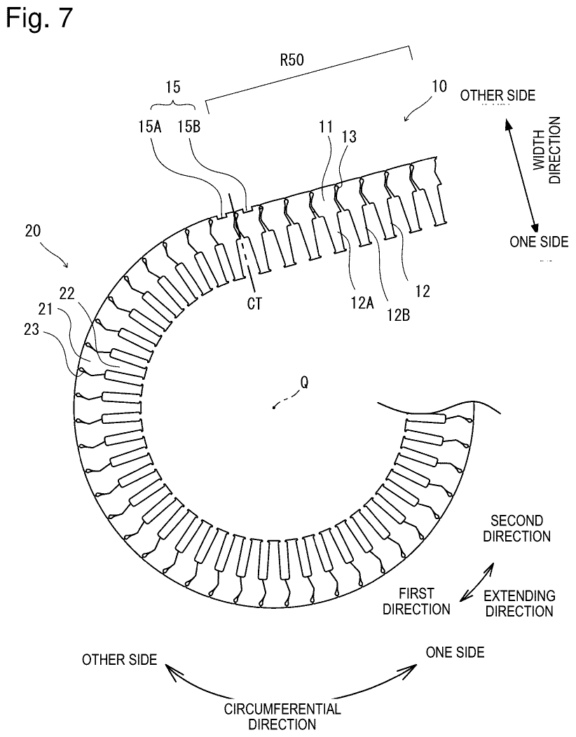

Next, a method S1 for manufacturing the laminated core according to the first exemplary embodiment of the present invention will be described with reference to FIGS. 5 to 7. FIG. 5 is a flowchart illustrating the method S1 for manufacturing the laminated core 1 according to the first embodiment. FIG. 6 illustrates punching of a steel sheet 9. FIG. 7 is a diagram for explaining a stacking step and a cutting step.

The method S1 for manufacturing the laminated core 1 is a method for manufacturing the cylindrical laminated core 1 extending along the axis Q as illustrated in FIG. 1, by spirally winding the iron core piece forming member 10 extending in a band shape in one direction while deforming the iron core piece forming member toward one side in the width direction.

More specifically, the method S1 for manufacturing the laminated core 1 includes a punching step S11, a stacking step S12, a cutting step S13, and a connecting step S14.

In the punching step S11, as illustrated in FIG. 6, the iron core piece forming member 10 is formed by punching the plate-shaped steel sheet 9 that is a magnetic material. Specifically, regions R1, R2, and R3 indicated by hatching in FIG. 6 are punched in the steel sheet 9. By punching the region R1 of the steel sheet 9, the tooth portion 12 is formed. By punching the region R2 of the steel sheet 9, the slit 13 extending from an end surface on one side in the width direction of the back yoke portion 11 to the other side in the width direction is formed. By punching the region R3 of the steel sheet 9, an end surface on the other side in the width direction of the back yoke portion 11 and the pair of recesses 15A and 15B are formed.

As illustrated in FIG. 6, the iron core piece forming member 10 obtained by punching the steel sheet 9 includes the back yoke portion 11, the plurality of tooth portions 12, the plurality of slits 13, and the pair of recesses 15.

The back yoke portion 11 is a plate-like portion extending in the one direction. The plurality of tooth portions 12 protrude to one side in the width direction from the back yoke portion 11.

The plurality of slits 13 extend from an end surface on one side in the width direction toward the other side in the width direction in the back yoke portion 11, between a pair of tooth portions 12A and 12B adjacent to each other in the one direction among the plurality of tooth portions 12.

The pair of recesses 15 is located at the end on the other side in the width direction in the back yoke portion 11. The pair of recesses 15 includes the recess 15A and the recess 15B.

Next, in the stacking step S12, as illustrated in FIG. 7, the iron core piece forming member 10 is deformed to one side in the width direction and spirally wound, and the back yoke portions 11, the tooth portions 12, the slits 13, and the recesses 15 are each stacked in the axial direction. The stacking direction of the iron core piece forming member 10 may be either one side or the other side in the thickness direction of the iron core piece forming member 10.

Next, in the cutting step S13, as illustrated in FIG. 7, in a state where the iron core piece forming member 10 is stacked in the axial direction, the iron core piece 20 is formed by cutting the part between the one recess 15A and the other recess 15B of the pair of recesses 15 at the cutting line CT. In the iron core piece forming member 10, since the slit 13 is located between the recess 15A on one side and the recess 15B on the other side in the pair of recesses 15, the iron core piece 20 can be easily cut out from the iron core piece forming member 10.

Next, in the connecting step S14, the back yoke portions 11 are joined to be connected by welding in the stacking direction on the outer peripheral surface 512 of the back yoke stacked portion 51 in which the back yoke portions 11 are stacked in the axial direction, at the recess 15A close to the cut end of the iron core piece 20. As a result, the first connecting portion 551 of the laminated core 1 as illustrated in FIGS. 1 to 4 is formed.

The laminated core 1 illustrated in FIGS. 1 to 4 is obtained by the method S1 for manufacturing the laminated core 1 described above. In the method S1 for manufacturing the laminated core 1 described above, the first connecting portion 551 connecting the back yoke portions 21 in the stacking direction is formed on the outer peripheral surface 512 of the back yoke stacked portion 51 in the recess 15A close to the cut end of the iron core piece 20. This makes it possible to prevent the end of the iron core piece 20 from being curled.

In the above configuration, the iron core piece 20 is formed by cutting the part between the recess 15A and the other recess 15B of the pair of recesses 15, in a state where the iron core piece forming member 10 is spirally stacked in the axial direction. That is, the iron core piece forming member 10 spirally stacked in the axial direction is cut into the iron core piece 20 and the remaining portion R50 obtained by cutting out the iron core piece 20.

In the iron core piece 20, the recess 15A close to the cut end can be used as a forming portion of a connecting portion that connects the back yoke portions 21 by joining in the stacking direction by welding or the like. By performing welding in the forming portion, it is possible to suppress protrusion of the connecting portion radially outward from the outer peripheral surface 512 of the back yoke stacked portion 51 at the time of welding, or to suppress a protruding dimension.

The recess 15B is also located near the cut end of the remaining portion R50. The recess 15B close to the cut end of the remaining portion R50 can be used as a forming portion of the connecting portion in the remaining portion R50. That is, when another iron core piece 20 is manufactured by spirally staking the remaining portion R50 in the axial direction as described above, the recess 15B can be used as a forming portion of the first connecting portion 551.

Therefore, it is possible to suppress generation of an end material between the iron core piece 20 and the remaining portion R50.

Therefore, according to the above-described configuration, it is possible to reduce a portion discarded when the iron core piece 20 is cut out in the manufacturing process of the laminated core 1.

Further, from another point of view, it is as follows. In the laminated core 1 described above, the first connecting portion 551 is located on the outer peripheral surface 512 of the portion of the back yoke stacked portion 51 including the one side end portion 251 in the extending direction of the iron core piece 20. Therefore, it is possible to prevent the one-side end portion 251 of the iron core piece 20 in the extending direction from being curled.

Moreover, in the above configuration, on the outer peripheral surface 512 of the back yoke stacked portion 51, the first groove 552 is located in a direction opposite to the first direction from the one side edge 252 toward the other side edge 262 in the iron core piece 20 across the one side edge 252 in the extending direction of the iron core piece 20 with respect to the first connecting portion 551. Furthermore, the first groove 552 extends in the stacking direction of the back yoke stacked portion 51 on the outer peripheral surface 512 of the back yoke stacked portion 51.

In the punching step S11 of the method S1 for manufacturing the laminated core 1 described above, the iron core piece forming member 10 is formed with the pair of recesses 15 arranged at a predetermined interval at the other end in the width direction of the back yoke portion 21.

Thereafter, in the stacking step S12, the iron core piece forming member 10 is spirally wound and stacked, and in the cutting step S13, the iron core piece forming member 10 is cut at a predetermined length to obtain the iron core piece 20 constituting the lamination 50. When the iron core piece forming member 10 is cut between the pair of two aligned recesses 15 in the cutting step S13, the recess 15A on the iron core piece 20 side can be used for forming the first connecting portion 551. On the other hand, in the iron core piece forming member 10, the recess 15B of the remaining portion R50 after the iron core piece is cut can also be used as a forming portion of a connecting portion of a lamination constituted by another iron core piece.

Therefore, when the iron core piece 20 constituting the lamination 50 is cut from the iron core piece forming member 10 with the one side edge 252 as a boundary, another iron core piece constituting another laminate can be cut out from the remaining iron core piece forming member without generating an end material.

Therefore, according to the above-described configuration, it is possible to obtain the laminated core 1 enabling reduction of a portion discarded when the iron core piece 20 constituting the lamination 50 is cut out from the iron core piece forming member 10 in the manufacturing process of the laminated core 1.

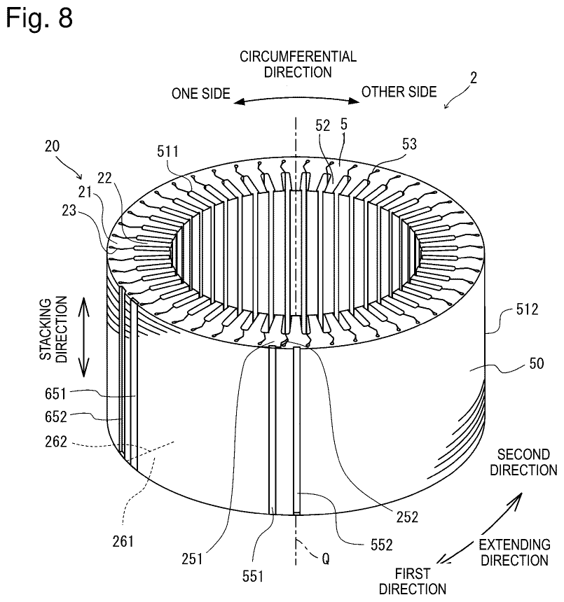

With reference to FIG. 8, a laminated core 2 according to a second exemplary embodiment of the present invention will be described. FIG. 8 is a perspective view illustrating a schematic configuration of the laminated core 2 according to the second embodiment. The laminated core 2 according to the second embodiment is different from the laminated core 1 according to the first embodiment in further including a second connecting portion and a second groove. In the below description, the same components as those in the first embodiment will be denoted by the same reference numerals and the description thereof will be omitted. Only the parts different from the constituent elements in the first embodiment will be described.

As illustrated in FIG. 8, a second connecting portion 651 connects the back yoke portions 21 in the staking direction on the outer peripheral surface 512 of the portion of the back yoke stacked portion 51 including the other side end portion 261 in the extending direction of the iron core piece 20. The second connecting portion 651 is realized by welding, in the staking direction, the back yoke portions 21 staked in the staking direction, for example.

When the laminated core 2 is viewed in the axial direction, a second groove 652 is located in a direction opposite to a second direction that is a direction from the other side edge 262 toward one side edge 252 in the iron core piece 20 across the other side edge 262 in the extending direction of the iron core piece 20 with respect to the second connecting portion 651, and extends in the stacking direction of the back yoke stacked portion 51 on the outer peripheral surface 512 of the back yoke stacked portion 51.

Therefore, when the iron core piece 20 constituting the lamination 50 is cut from the iron core piece forming member 10 with the other side edge 262 as a boundary, another iron core piece constituting another laminate can be cut out from the remaining iron core piece forming member without generating an end material.

Therefore, according to the above-described configuration, it is possible to obtain the laminated core 1 enabling reduction of a portion discarded when the iron core piece 20 constituting the lamination 50 is cut out from the iron core piece forming member 10 in the manufacturing process of the laminated core 1.

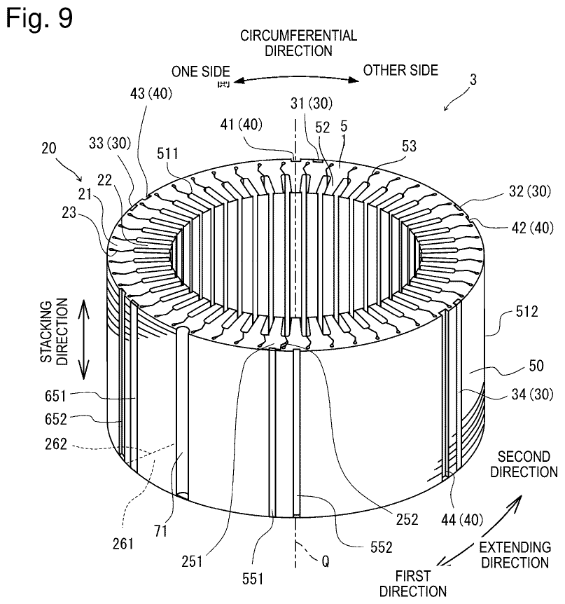

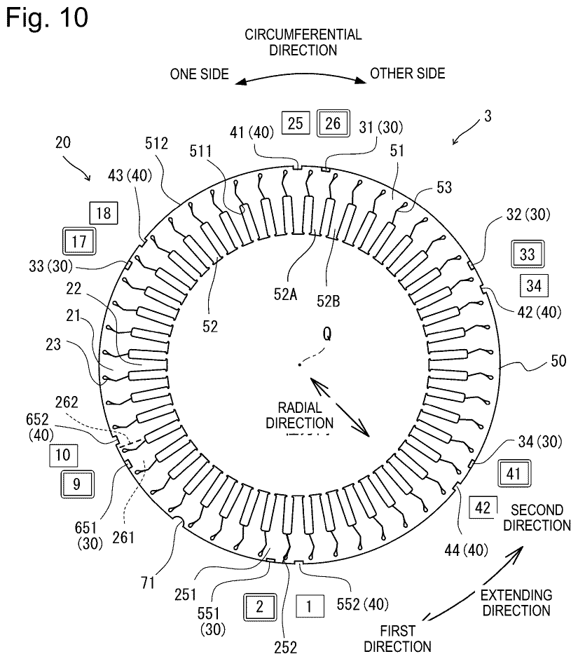

With reference to FIGS. 9 and 10, a laminated core 3 according to a third exemplary embodiment of the present invention will be described. FIG. 9 is a perspective view illustrating a schematic configuration of the laminated core 3 according to the third embodiment. FIG. 10 is a plan view illustrating a schematic configuration of the laminated core 3 illustrated in FIG. 9.

The laminated core 3 according to the third embodiment is different from the laminated core 2 according to the second embodiment in that the laminated core 3 includes a plurality of connecting portions 30 including the first connecting portion 551 and the second connecting portion 651, a plurality of grooves 40 including the first groove 552 and the second groove 652, and a positioning groove 71. In the below description, the same components as those in the second embodiment will be denoted by the same reference numerals and the description thereof will be omitted. Only the parts different from the constituent elements in the second embodiment will be described.

In the below description, a region including a portion of the back yoke portion 11 located between the adjacent slits 13 in the iron core piece forming member 10 and the tooth portion 12 protruding to one side in the width direction from the portion and the number when counting the regions are referred to as “sections”. In the iron core piece 20 constituting the laminated core 3, a region including a portion of the back yoke portion 21 located between the adjacent slits 23 and the tooth portion 22 protruding radially inward of the spiral from the portion and the number when counting the regions are also referred to as “sections”.

The iron core piece 20 is formed by spirally winding the iron core piece forming member 10 a plurality of rounds in which 48 sections constitute one round. That is, when the laminated core 3 is viewed in the axial direction, one round in the circumferential direction of the iron core piece 20 constituting the lamination 50 of the laminated core 3 includes 48 sections.

As illustrated in FIGS. 9 and 10, the laminated core 3 includes six connecting portions 30 including the first connecting portion 551 and the second connecting portion 651, six grooves 40 including the first groove 552 and the second groove 652, and the positioning groove 71.

The positioning groove 71 extends in the stacking direction of the back yoke stacked portion 51 on the outer peripheral surface 512 of the back yoke stacked portion 51. The depth of the positioning groove 71 is larger than the depths of the first groove 552 and the second groove 652.

According to the above configuration, for example, the laminated core 3 can be easily positioned by hooking a jig or the like to the positioning groove 71.

Moreover, when the laminated core 3 is viewed in the axial direction, the groove 40 is positioned on the outer circumferential surface of the laminated core 3 so as to be aligned with the connecting portion 30 with the slit stacked portion 53 being interposed therebetween.

Therefore, in the iron core piece forming member 10, when the slit 23 is located near the one side end portion 251 in the extending direction of the iron core piece 20, the iron core piece 20 can be easily cut out from the iron core piece forming member 10 in the manufacturing process of the laminated core 3.

The plurality of connecting portions 30 are positioned side by side in the circumferential direction on the outer peripheral surface 512 of the back yoke stacked portion 51 when the back yoke stacked portion 51 is viewed in the axial direction, and connect the back yoke stacked portions 51 in the stacking direction. The plurality of connecting portions 30 include a first intermediate connecting portion 31, a second intermediate connecting portion 32, a third intermediate connecting portion 33, and a fourth intermediate connecting portion 34, in addition to the first connecting portion 551 and the second connecting portion 651. As a result, the lamination 50 can be more reliably connected in the stacking direction by the plurality of connecting portions 30.

The plurality of grooves 40 are positioned side by side in the circumferential direction with respect to the plurality of connecting portions 30 on the outer peripheral surface 512 of the back yoke stacked portion 51 when the back yoke stacked portion 51 is viewed in the axial direction, and extend in the stacking direction of the back yoke stacked portion 51. The plurality of grooves 40 include a first intermediate groove 41, a second intermediate groove 42, a third intermediate groove 43, and a fourth intermediate groove 44, in addition to the first groove 552 and the second groove 652.

As described above, since the plurality of grooves 40 are arranged side by side with respect to the plurality of connecting portions 30, in the manufacturing process of the laminated core 3, in the iron core piece forming member 10, the recess for forming the connecting portion 30 and the recess for forming the groove 40 are positioned side by side. Therefore, in the manufacturing process of the laminated core 3, the iron core piece 20 can be cut out by cutting the part between the recess for forming the connecting portion 30 and the recess for forming the groove 40 in the iron core piece forming member 10. Therefore, the degree of freedom of the position where the iron core piece 20 is cut out is improved.

The advantages of the laminated core 3 will be described more specifically with reference to a method for manufacturing a conventional laminated core 903 and the method of manufacturing the laminated core 3 in order.

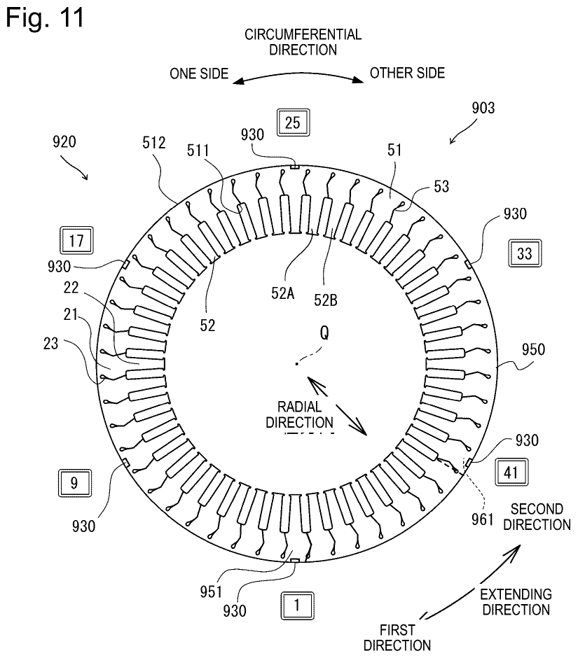

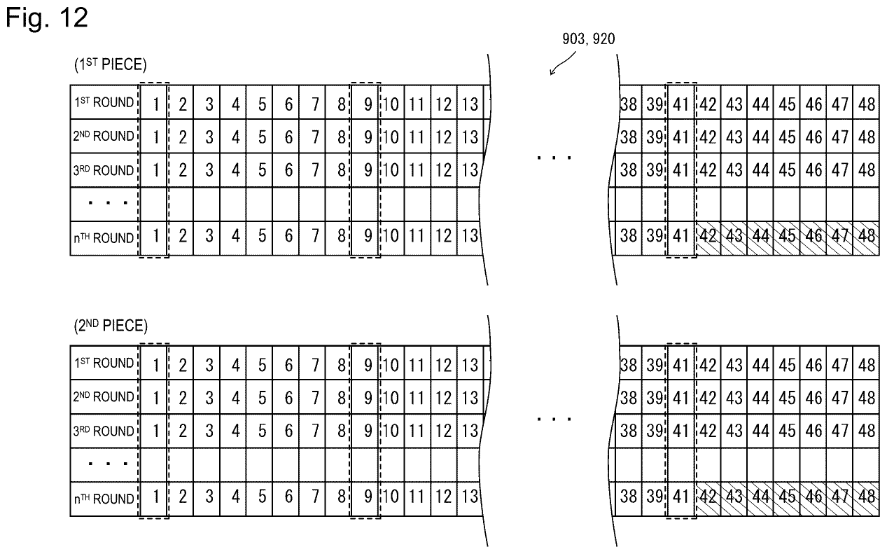

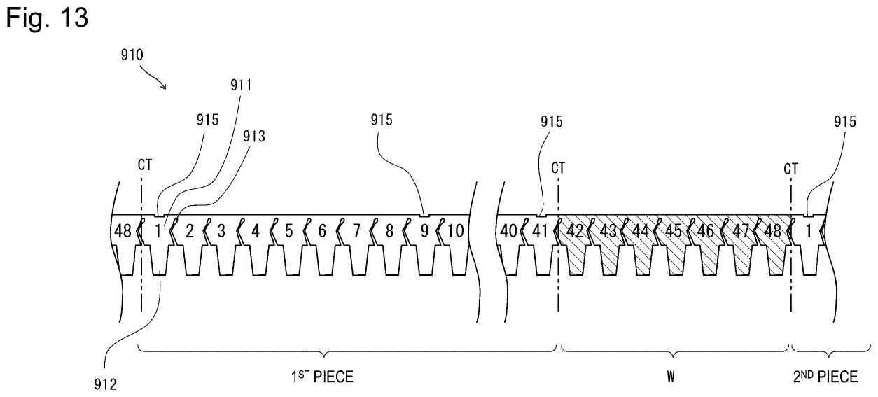

A method for manufacturing the conventional laminated core 903 will be described with reference to FIGS. 11 to 13. FIG. 11 is a plan view illustrating an iron core piece forming member 910 for manufacturing the conventional laminated core 903. FIG. 12 is a lamination pattern table of the conventional laminated core 903. FIG. 13 is a plan view illustrating an iron core piece forming member 910 for manufacturing the laminated core 903. A difference between the conventional laminated core 903 and the laminated core 3 according to third embodiment lies in that the laminated core 3 according to third embodiment has a plurality of grooves 40, whereas the conventional laminated core 903 does not have such grooves.

A lamination 950 included in the conventional laminated core 903 includes iron core pieces 920 laminated in a spiral shape. The iron core piece 920 is cut out from the iron core piece forming member 910. The lamination pattern table illustrated in FIG. 12 indicates the number of windings of the spiral iron core piece 920 and the section number in the number of windings. As illustrated in FIG. 13, the iron core piece forming member 910 includes a back yoke portion 911, a plurality of tooth portions 912, a plurality of slits 913, and a recess 915.

The iron core piece 920 is formed by spirally winding the iron core piece forming member 910 illustrated in FIG. 13 a plurality of times from the first section of the first round to the 42 section of the nth round with 48 sections as one round. In the iron core piece 905, sections located in the stacking direction are denoted by the same reference numerals. In FIGS. 11 to 13, the laminated core 903 and the sections of the iron core piece forming member 910 corresponding to the sections of the iron core piece 920 are denoted by the same reference numerals.

The laminated core 903 includes a plurality of connecting portions 930. In FIG. 11, the numbers of the sections where the plurality of connecting portions 930 are located are indicated by double frame enclosing. In addition, in the lamination pattern table illustrated in FIG. 12, a frame surrounded by a broken line represents a section where the plurality of connecting portions 930 are located. The connecting portion 930 is located at the one side end portion 951 in the extending direction of the iron core piece 920. Further, the connecting portion 930 is located at the other side end portion 961 in the extending direction of the iron core piece 920.

As illustrated in FIG. 11, the plurality of connecting portions 930 are located at sections No. 1, No. 9, No. 17, No. 25, No. 33, and No. 41. The plurality of connecting portions 930 correspond to the recesses 915 of the iron core piece forming member 910 illustrated in FIG. 13. In FIG. 13, the sections of the recesses 915 corresponding to the plurality of connecting portions 930 are indicated by shading.

The pattern of the above-described section is similar in the first, second, . . . , and n^{th} rounds of the first device. Moreover, the second and subsequent devices also have the same section pattern as the first device. In order to prevent the one side end portion 951 and the other side end portion 961 in the extending direction of the iron core piece 920 from being curled, in the laminated core 903, the connecting portion 930 is located in the first section in which the one side end portion 951 in the extending direction of the iron core piece 920 is located and the 41st section in which the other side end portion 961 is located.

Therefore, when the first and second laminated cores 903 are manufactured according to the pattern table illustrated in FIG. 12, as indicated by hatching in FIGS. 12 and 13, in the laminated core 903 of each of the first and second laminated iron cores, the sections from 42 to 48 in the nth round of the final round are the end materials W. The generation of the end material W is similar in the third and subsequent stages.

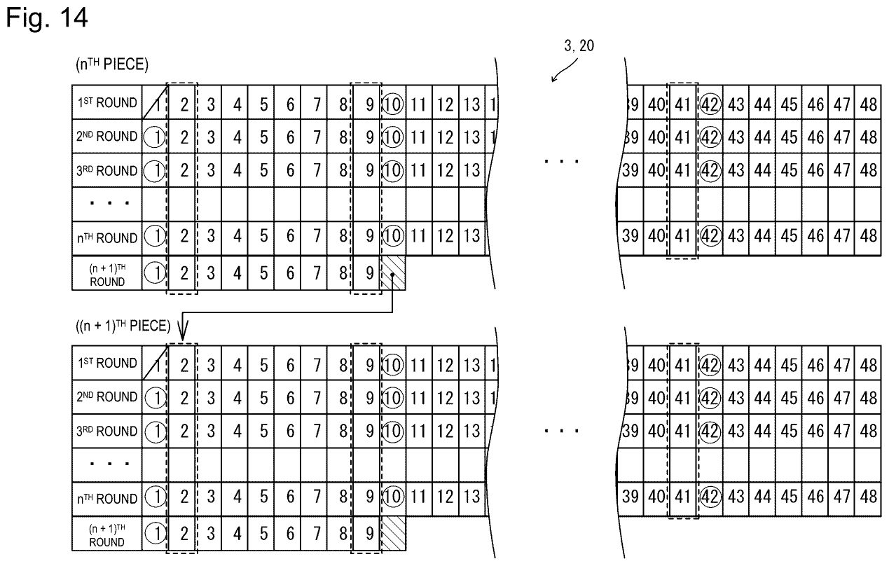

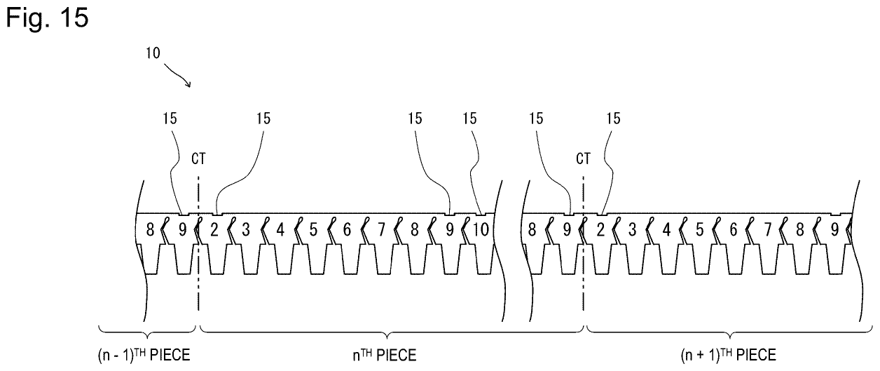

A method for manufacturing the laminated core 3 according to the third embodiment will be described with reference to FIGS. 14 and 15 as well as FIGS. 9 and 10 again. FIG. 14 is a lamination pattern table of the laminated core 3 according to the third embodiment. FIG. 15 is a plan view illustrating an iron core piece forming member 10 for manufacturing the laminated core 3 according to the third embodiment.

In FIG. 10, the section numbers where the plurality of connecting portions 30 are located are indicated by double frame enclosure. In addition, the section numbers where the plurality of grooves 40 are located are indicated by single frame enclosure. In the lamination pattern table illustrated in FIG. 14, a frame surrounded by a broken line represents a section where the connecting portion 30 corresponding to the recess 15 is located, and a circle represents a section where the groove 40 corresponding to the recess 15 of the iron core piece forming member 10 illustrated in FIG. 15 is located.

The pattern table illustrated in FIG. 14 indicates a spiral round of the iron core piece 20 and the section numbers in the round. In the pattern table illustrated in FIG. 14, a circle indicates a section in which a groove corresponding to the recess 15 is located, and a frame surrounded by a broken line indicates a section in which a connecting portion corresponding to the recess 15 is located. In addition, the double frame enclosure means that the connecting portion is located in the section, and the single frame enclosure means that the groove is positioned in the section. In addition, in the lamination pattern table illustrated in FIG. 14, a frame surrounded by a broken line represents a section where the plurality of connecting portions 30 are located. The plurality of connecting portions 30 correspond to the recesses 15 of the iron core piece forming member 10 illustrated in FIG. 15. In FIG. 15, the sections of the recesses 15 corresponding to the plurality of connecting portions 30 are indicated by shading.

In FIG. 10, the first connecting portion 551 located at the one side end portion 251 in the extending direction of the iron core piece 20 is located at the section No. 2. That is, the first round of the iron core piece 20 starts from No. 2. The first groove 552 is located at the section No. 1. That is, the first groove 552 is located at the head of the second round of the iron core piece 20.

Next, in the first round of the iron core piece 20, the connecting portion 30 subsequent to the first connecting portion 551 is located at the section No. 9. Thereafter, the connecting portion 30 is located at each of the sections No. 17, No. 26, No. 33, and No. 41. The second round subsequent thereto begins with the section No. 1. Therefore, in the iron core piece forming member 10 illustrated in FIG. 15, the recesses 15 are formed at the sections No. 2, No. 9, No. 17, No. 26, No. 33, and No. 41 corresponding to the plurality of connecting portions 30 in the iron core piece 20. In the iron core piece forming member 10, the recess 15 is also formed at the section adjacent to the section where the connecting portion 30 is located in the iron core piece 20. That is, the recess 15 is formed at each of the sections No. 1, No. 10, No. 18, No. 25, No. 34, and No. 42 corresponding to the plurality of grooves 40 in the iron core piece 20.

The second to nth rounds are the same as the first round except that the rounds begin from the section No. 1. As described above, the recess 15 is formed at the section No. 1. The (n+1)^{th} round, which is the final round, ends at the section No. 9 where the other side end portion 261 in the extending direction of the iron core piece 20 is located. The second connecting portion 651 is located at the section No. 9. Therefore, the n^{th} iron core piece 20 and the (n+1)^{th} iron core piece 20 are separated by cutting the iron core piece forming member 10 between the section No. 9 in the (n+1)^{th} round of the nth iron core piece 20 and the section next to the section No. 9. The section next to the section No. 9 is used as the section No. 2 of the first round of the (n+1)^{th} iron core piece 20.

With the above configuration, the last section No. 9 of the last round of the n^{th} iron core piece 20 and the section No. 2 of the first round of the (n+1)^{th} iron core piece 20 each have the recess 15. Therefore, the recess 15 can be used as a portion for forming the connecting portion. Therefore, the connecting portions 30 can be formed at both ends in the extending direction of the iron core piece 20, and it is possible to suppress generation of an end material between the last section of the n^{th} iron core piece 20 and the first section of the (n+1)^{th} iron core piece 20. In addition, according to the above-described configuration, the laminated core 3 can be continuously produced while suppressing the generation of an end material. Note that the conventional method for manufacturing the laminated core 903 described with reference to FIGS. 11 to 13 is merely an example for describing the advantage of the laminated core 3. That is, the laminated core 3 can achieve the object of suppressing generation of an end material not only in the conventional laminated core 903 described above but also in a wide range.

Further, from another point of view, in the laminated core 3, the first intermediate connecting portion 31 is located at a point symmetrical position with the axis Q being the center with respect to the first connecting portion 551 when the laminated core 3 is viewed in the axial direction. That is, the first intermediate connecting portion 31 is located at the section No. 26 in the example of the above-described embodiment.

The second intermediate connecting portion 32 is located at a point symmetrical position with the axis Q being the center with respect to the second connecting portion 651 when the laminated core 3 is viewed in the axial direction. That is, the second intermediate connecting portion 32 is located at the section No. 33 in the example of the above-described embodiment.

The third intermediate connecting portion 33 is located at the section No. 17 in the example of the above-described embodiment. The fourth intermediate connecting portion 34 is located at the section No. 41 in the example of the above-described embodiment.

In addition, the first groove 552 is located at the section No. 1 in the example of the above-described embodiment. The second groove 652 is located at the section No. 10 in the example of the above-described embodiment.

The first intermediate groove 41 is located at the section No. 25 in the example of the above-described embodiment. The second intermediate groove 42 is located at the section No. 34 in the example of the above-described embodiment. The third intermediate groove 43 is located at the section No. 18 in the example of the above-described embodiment. The fourth intermediate groove 44 is located at the section No. 44 in the example of the above-described embodiment.

In the example of the above-described embodiment, the number of sections located between the first connecting portion 551 and the second connecting portion 651 in the circumferential direction of the laminated core 3 is “six”, which is the same as the number of sections located between the first intermediate connecting portion 31 and the second intermediate connecting portion 32.

Therefore, in the circumferential direction of the laminated core 3, the number of teeth located between the first connecting portion 551 and the second connecting portion 651 is “six”, which is the same as the number of teeth located between the first intermediate connecting portion 31 and the second intermediate connecting portion 32.

In the above configuration, in the circumferential direction of the lamination 50, the number of teeth located between the first connecting portion 551 and the second connecting portion 651 is the same as the number of teeth located between the first intermediate connecting portion 31 and the second intermediate connecting portion 32 that are located at point-symmetrical positions with the axis Q being the center with respect to the first connecting portion 551 and the second connecting portion 651.

For this reason, since the back yoke portions 21 are connected in the stacking direction in a well-balanced manner between the connecting portions located at point-symmetrical positions, distortion hardly occurs in the laminated core 3.

From another point of view, in the laminated core 3, the number of the plurality of connecting portions 30 is an even number since it is six. In addition, the plurality of connecting portions 30 include the first intermediate connecting portion 31 as a third connecting portion located at a point symmetrical position with the axis Q being the center with respect to the first connecting portion 551 when the laminated core is viewed in the axial direction. In addition, the plurality of connecting portions 30 include the second intermediate connecting portion 32 as a third connecting portion located at a point symmetrical position with the axis Q being the center with respect to the second connecting portion 651 when the laminated core is viewed in the axial direction.

In the above configuration, in the cylindrical laminated core 3, since the first connecting portion 551 or the second connecting portion 651 and the third connecting portion are located at point-symmetrical positions with the axis Q being the center, distortion is less likely to occur in the laminated core 3.

The foregoing description concerns embodiments of the present invention; however, the foregoing embodiments are merely examples for embodying the present invention. Thus, the above-described embodiments can be appropriately modified and implemented within a range without departing from the gist thereof and being limited to the above-described embodiment.

In each of the above-described embodiments, the laminated cores 2 and 3 have a plurality of connecting portions and a plurality of grooves. However, the number of connecting portions and the number of grooves may be one. For example, in the second embodiment, either the first connecting portion and the first groove or the second connecting portion and the second groove may be omitted.

In each of the above-described embodiments, when the laminated core 1 is viewed in the axial direction, the first groove 552 is located on the outer peripheral surface 512 of the back yoke stacked portion 51 so as to be aligned with the first connecting portion 551 in the circumferential direction with the slit stacked portion 53 being interposed therebetween. However, the first groove may not be located side by side with the first connecting portion in the circumferential direction with the slit stacked portion being interposed therebetween.

In each of the above-described embodiments, the iron core piece forming member 10 has the recess 15 in each of two sections arranged in one direction at a predetermined interval. However, in the iron core piece forming member, a recess may be formed in each of the three or more sections arranged in one direction at predetermined intervals. A recess may be formed in each section. As a result, the degree of freedom of the section in which the connecting portion can be formed is improved. In each of the above-described embodiments, in the

slit stacked portion 53, the plurality of slits 23 are laminated in the thickness direction. Here, the shape of each of the plurality of slits is not particularly limited. The slit may have any of a linear shape, a curved shape, and a bent shape, for example. In addition, in the slit stacked portion, two slits adjacent to each other in the staking direction may not have the same shape.

In the third embodiment described above, the connecting portion 30, the groove 40, and the recess 15 are located in the specific sections illustrated in FIGS. 9, 10, 14, and 15. However, in the laminated core, the positions of the connecting portion, the groove, and the recess are not limited to the specific sections illustrated in FIGS. 9, 10, 14, and 15.

For example, in the third embodiment described above, one round of the iron core piece 20 in the circumferential direction includes forty eight sections including a portion of the back yoke portion 11 located between the adjacent slits 13 in the iron core piece forming member 10 and the tooth portion 12 protruding from the portion of the back yoke portion 11 to one side in the width direction. However, the number of sections per round of the iron core piece in the circumferential direction may be larger or smaller than forty eight. One round of the iron core piece in the circumferential direction may be configured of an arbitrary number of sections.

For example, in the third embodiment described above, while the first intermediate connecting portion 31 is located at the section No. 26, the first intermediate groove 41 located at the section adjacent to the first intermediate connecting portion 31 is located at the section No. 25. However, the position of the first intermediate connecting portion and the position of the first intermediate groove may be interchanged. The positions of the second intermediate connecting portion to the fourth intermediate connecting portion and the positions of the second intermediate groove to the fourth intermediate groove can be exchanged.

In the third embodiment described above, the laminated core 3 has the positioning groove 71. However, the laminated core may not have the positioning groove.

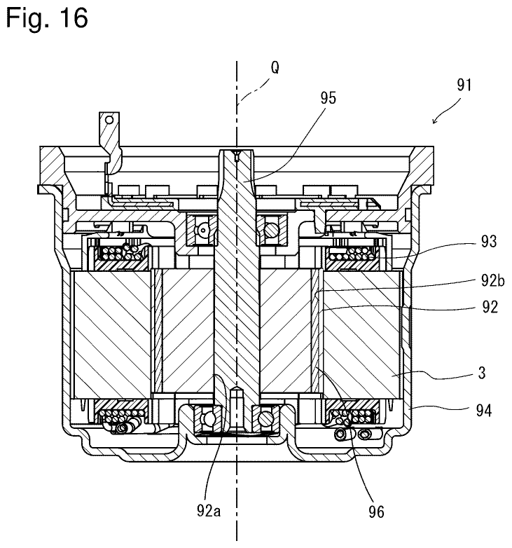

In addition, a motor including the laminated cores 1, 2, and 3 according to the above-described embodiments is also within the scope of the present invention. A motor 91 including the laminated core 3 will be exemplarily described with reference to FIG. 16. FIG. 16 is a cross-sectional view illustrating a schematic configuration of the motor 91 according to an exemplary embodiment of the present invention.

As illustrated in FIG. 16, the motor 91 includes a rotor 92 as a rotor, a laminated core 3 as a stator, a housing 94, and a shaft 95. The rotor 92 has a through hole 92a extending along the axis Q. The shaft 95 is fixed to the rotor 92 in a state of penetrating the through hole 92a in the axial direction. The rotor 92 is located radially inward of the laminated core 3 so as to be rotatable together with the shaft 95 about the axis Q. That is, the motor 91 is a so-called inner rotor type motor. The rotor 92 has a magnet insertion hole 92b extending in parallel with the through hole 92a. The magnet 96 is located in the magnet insertion hole 92b.

The laminated core 3 is accommodated in the housing 94. A stator coil 93 is wound around the laminated core 3.

According to the motor 91 described above, it is possible to suppress generation of an end material of the iron core piece in the manufacturing process of the motor. The motor 91 includes the laminated core 3 as a stator. However, the motor 91 may include the laminated core 1 or the laminated core 2 as a stator. The motor may include a laminated core as a rotor. That is, the laminated core according to each of the above-described embodiments can constitute at least one of a stator and a rotor of a motor. That is, the motor includes a stator and a rotor. At least one of the stator and the rotor has the above-described laminated core.

The present technique can also have configurations as described below.

(1) A laminated core includes a lamination having a cylindrical shape and extending along an axis, the lamination being formed of an iron core piece, the iron core piece including a back yoke portion having plate shape and extending in a shape of a spiral about an axis; a plurality of tooth portions protruding inward in a radial direction of the spiral from the back yoke portion; and a plurality of slits extending radially outward of the spiral from an inner peripheral end surface of the back yoke portion between a pair of the tooth portions adjacent to each other in the extending direction among the plurality of tooth portions, the back yoke portions, the tooth portions, and the slits being laminated in a state of overlapping each other in a thickness direction respectively. The lamination includes a cylindrical back yoke stacked portion in which the back yoke portions are stacked in the thickness direction, a plurality of tooth stacked portions in which the plurality of tooth portions are stacked in the thickness direction, arranged in a circumferential direction, and protruding radially inward from the inner peripheral surface of the back yoke stacked portion, and a plurality of slit stacked portions in which the plurality of slits are stacked in the thickness direction, arranged in the circumferential direction, and extending radially outward from an inner peripheral end surface of the back yoke stacked portion between a pair of the tooth stacked portions adjacent to each other. The laminated core includes a first connecting portion that connects the back yoke portions in the stacking direction on an outer peripheral surface of a portion of the back yoke staked portion, the portion including an end portion on one side in the extending direction of the iron core piece, and a first groove that is located in a direction opposite to a first direction that is a direction from one side edge toward the other side edge in the iron core piece across the one side edge in the extending direction of the iron core piece with respect to the first connecting portion, and extends in the stacking direction of the back yoke stacked portion on the outer peripheral surface of the back yoke stacked portion.

(2) The laminated core according to (1) further includes: a second connecting portion that connects the back yoke portion in the stacking direction on an outer peripheral surface of a portion of the back yoke stacked portion, the portion including an end portion on the other side in the extending direction of the iron core piece; and a second groove located in a direction opposite to a second direction that is a direction from the other side edge toward the one side edge in the iron core piece across the other-side edge in the extending direction of the iron core piece with respect to the second connecting portion when the laminated core is viewed in the axial direction, the second groove extending in the stacking direction of the back yoke stacked portion on an outer peripheral surface of the back yoke stacked portion, in which the first groove, the first connecting portion, the second connecting portion, and the second groove are arranged in this order in the first direction on the outer peripheral surface of the back yoke staked portion when the laminated core is viewed in the axial direction.

(3) The laminated core according to (2) further includes: a plurality of connecting portions that are located side by side in the circumferential direction on the outer peripheral surface of the back yoke stacked portion when the back yoke stacked portion is viewed in the axial direction, and connect the back yoke stacked portion in the stacking direction; and a plurality of grooves located side by side in the circumferential direction with respect to the plurality of connecting portions on the outer peripheral surface of the back yoke stacked portion when the back yoke stacked portion is viewed in the axial direction, and extending in the stacking direction of the back yoke stacked portion, in which the plurality of connecting portions include the first connecting portion and the second connecting portion, and the plurality of grooves include the first groove and the second groove.

(4) The laminated core according (3) further includes: a first intermediate connecting portion located at a point symmetrical position with the axis being a center with respect to the first connecting portion when the laminated core is viewed in the axial direction; and a second intermediate connecting portion located at a point symmetrical position with the axis being the center with respect to the second connecting portion when the laminated core is viewed in the axial direction, in which a number of teeth located between the first connecting portion and the second connecting portion in the circumferential direction of the laminated core is equal to a number of teeth located between the first intermediate connecting portion and the second intermediate connecting portion.

(5) In the laminated core according to (3) or (4), the number of the plurality of connecting portions is an even number, and the laminated core further includes a third connecting portion located at a point symmetrical position with the axis being the center with respect to the first connecting portion or the second connecting portion when the laminated core is viewed in the axial direction.

(6) The laminated core according any one of (3) to (5) further includes a positioning groove extending in the stacking direction of the back yoke stacked portion on the outer peripheral surface of the back yoke stacked portion, and in the laminated core, the depth of the positioning groove is larger than the depths of the first groove and the second groove.

(7) In the laminated core according to any one of (3) to (6), the groove is located on an outer peripheral surface of the laminated core so as to be arranged side by side with the connecting portion in the circumferential direction across the slit stacked portion when the laminated core is viewed in an axial direction.

(8) A motor includes a stator and a rotor. At least one of the stator and the rotor includes the laminated core according to any one of (1) to (7).

(9) A laminated core manufacturing method is a method for manufacturing a laminated core having a cylindrical shape and extending along the axis, by spirally winding an iron core piece forming member extending in a band shape in one direction while deforming the iron core piece forming member toward one side in the width direction. The laminated core manufacturing method includes a punching step of punching a plate-shaped steel sheet to form the iron core piece forming member, the iron cor piece forming member including: a back yoke portion having a plate shape and extending in the one direction; a plurality of tooth portions protruding from the back yoke portion to one side in the width direction; and a plurality of slits extending from an end face on one side in the width direction to another side in the width direction in the back yoke portion between a pair of the tooth portions adjacent to each other in the one direction among the plurality of tooth portions; and a pair of recesses located at end portions on the other side in the width direction in the back yoke portion, a stacking step of deforming the iron core piece forming member to one side in the width direction and winding the iron core piece forming member in a spiral shape, and stacking the back yoke portions, the tooth portions, the slits, and the recesses in the axial direction in an overlapping manner, respectively; a cutting step of forming an iron core piece by cutting between one recess and another recess of the pair of recesses in a state where the iron core piece forming member is stacked in the axial direction; and a connecting step of joining the back yoke portions in a stacking direction on an outer peripheral surface of a back yoke stacked portion in which the back yoke portions are stacked in the axial direction in a recess close to a cut end portion of the iron core piece.

The present invention is applicable to a laminated core formed by spirally winding a band-shaped iron core piece forming member, a motor, and a laminated core manufacturing method.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A laminated core comprising:
a lamination in a cylindrical shape and extending along an axis, the lamination including an iron core piece, the iron core piece including:
a back yoke portion having a plate shape and extending in a shape of a spiral about an axis;
a plurality of tooth portions protruding inward in a radial direction of the spiral from the back yoke portion; and
a plurality of slits extending outward in the radial direction of the spiral from an inner peripheral end surface of the back yoke portion between a pair of the tooth portions adjacent to each other in an extending direction among the plurality of tooth portions, the iron core piece being stacked in such a manner that the back yoke portions, the tooth portions, and the slits are stacked in a state of overlapping each other in a thickness direction respectively, wherein
the lamination includes:
a back yoke stacked portion in a cylindrical shape in which the back yoke portions are stacked in the thickness direction;
a plurality of tooth stacked portions in which the plurality of tooth portions are stacked in the thickness direction and arranged in the circumferential direction, the plurality of tooth stacked portions protruding radially inward from an inner peripheral surface of the back yoke stacked portion; and
a plurality of slit stacked portions in which the plurality of slits are stacked in the thickness direction and arranged in the circumferential direction, the plurality of slit stacked portions extending radially outward from an inner peripheral end surface of the back yoke stacked portion between a pair of the tooth stacked portions adjacent to each other, and
the laminated core includes:
a first connecting portion that connects the back yoke portion in the stacking direction on an outer peripheral surface of a portion of the back yoke stacked portion, the portion including an end portion on one side in the extending direction of the iron core piece; and
a first groove located in a direction opposite to a first direction that is a direction from one side edge toward another side edge in the iron core piece across the one side edge in the extending direction of the iron core piece with respect to the first connecting portion when the laminated core is viewed in the axial direction, the first groove extending in the stacking direction of the back yoke stacked portion on an outer peripheral surface of the back yoke stacked portion.

2. The laminated core according to claim 1, further comprising:
a second connecting portion that connects the back yoke portion in the stacking direction on an outer peripheral surface of a portion of the back yoke stacked portion, the portion including an end portion on the other side in the extending direction of the iron core piece; and
a second groove located in a direction opposite to a second direction that is a direction from the other side edge toward the one side edge in the iron core piece across the other-side edge in the extending direction of the iron core piece with respect to the second connecting portion when the laminated core is viewed in the axial direction, the second groove extending in the stacking direction of the back yoke stacked portion on an outer peripheral surface of the back yoke stacked portion, wherein
the first groove, the first connecting portion, the second connecting portion, and the second groove are arranged in this order in the first direction on the outer peripheral surface of the back yoke staked portion when the laminated core is viewed in the axial direction.

3. The laminated core according to claim 2, further comprising:
a plurality of connecting portions that are located side by side in the circumferential direction on the outer peripheral surface of the back yoke stacked portion when the back yoke stacked portion is viewed in the axial direction, and connect the back yoke stacked portion in the stacking direction; and
a plurality of grooves located side by side in the circumferential direction with respect to the plurality of connecting portions on the outer peripheral surface of the back yoke stacked portion when the back yoke stacked portion is viewed in the axial direction, and extending in the stacking direction of the back yoke stacked portion, wherein
the plurality of connecting portions include the first connecting portion and the second connecting portion, and
the plurality of grooves include the first groove and the second groove.

4. The laminated core according to claim 3, further comprising:
a first intermediate connecting portion located at a point symmetrical position with the axis being a center with respect to the first connecting portion when the laminated core is viewed in the axial direction; and
a second intermediate connecting portion located at a point symmetrical position with the axis being the center with respect to the second connecting portion when the laminated core is viewed in the axial direction, wherein
a number of teeth located between the first connecting portion and the second connecting portion in the circumferential direction of the laminated core is equal to a number of teeth located between the first intermediate connecting portion and the second intermediate connecting portion.

5. The laminated core according to claim 3, wherein
a number of the plurality of connecting portions is an even number, and
the laminated core further comprises a third connecting portion located at a point symmetrical position with the axis being the center with respect to the first connecting portion or the second connecting portion when the laminated core is viewed in the axial direction.

6. The laminated core according to claim 3, further comprising
a positioning groove extending in the stacking direction of the back yoke stacked portion on the outer peripheral surface of the back yoke stacked portion, wherein
a depth of the positioning groove is larger than depths of the first groove and the second groove.

7. The laminated core according to claim 6, wherein the groove is located on an outer peripheral surface of the laminated core and arranged side by side with the connecting portion in the circumferential direction across the slit stacked portion when the laminated core is viewed in an axial direction.

8. A motor comprising:
a stator; and
a rotor, wherein
at least one of the stator and the rotor includes the laminated core according to claim 1.

9. A laminated core manufacturing method for manufacturing a laminated core having a cylindrical shape and extending along an axis by spirally winding an iron core piece forming member extending in a band shape in one direction, while deforming the iron core piece forming member to one side in a width direction, the method comprising:
a punching step of punching a plate-shaped steel sheet to form the iron core piece forming member, the iron cor piece forming member including:
a back yoke portion having a plate shape and extending in the one direction;
a plurality of tooth portions protruding from the back yoke portion to one side in the width direction; and
a plurality of slits extending from an end face on one side in the width direction to another side in the width direction in the back yoke portion between a pair of the tooth portions adjacent to each other in the one direction among the plurality of tooth portions; and
a pair of recesses located at end portions on the other side in the width direction in the back yoke portion,
a stacking step of deforming the iron core piece forming member to one side in the width direction and winding the iron core piece forming member in a spiral shape, and stacking the back yoke portions, the tooth portions, the slits, and the recesses in an axial direction in an overlapping manner, respectively;
a cutting step of forming an iron core piece by cutting between one recess and another recess of the pair of recesses in a state where the iron core piece forming member is stacked in the axial direction; and
a connecting step of joining the back yoke portions in a stacking direction on an outer peripheral surface of a back yoke stacked portion in which the back yoke portions are stacked in the axial direction in a recess close to a cut end portion of the iron core piece.
